(19) United States
(12) Patent Application Publication
(10) Pub. No.: US 2024/0419865 A1
(43) Pub. Date: Dec. 19, 2024

(54) DIAGRAM ANALYSIS APPARATUS, DIAGRAM ANALYSIS METHOD, AND NON-TRANSITORY COMPUTER READABLE RECORDING MEDIUM

(71) Applicant: Yokogawa Electric Corporation, Tokyo (JP)

(72) Inventors: Satoshi ASAWA, Tokyo (JP); Takahiro KAMBE, Tokyo (JP); Masato ANNEN, Tokyo (JP)

(21) Appl. No.: 18/741,288

(22) Filed: Jun. 12, 2024

(30) Foreign Application Priority Data
Jun. 19, 2023 (JP) 2023-100332

(51) Int. Cl. G06F 30/20

(52) U.S. Cl. CPC G06F 30/20

(57) ABSTRACT

A diagram analysis apparatus includes a processor configured to extract, from a design diagram of a plant, components of the design diagram, and identify a setting position of setting information corresponding to an identification condition in the design diagram or a setting detail of the setting information in the design diagram or any combination thereof, based on the components of the design diagram.

### CROSS-REFERENCE TO RELATED APPLICATION

The present application claims priority to and incorporates by reference the entire contents of Japanese Patent Application No. 2023-100332 filed in Japan on Jun. 19, 2023.

### FIELD

The present invention relates to a diagram analysis apparatus, a diagram analysis method, and a non-transitory computer readable recording medium.

### BACKGROUND

A defect or a deficiency included in a design diagram, such as a Piping and Instrumentation Diagram (P&ID), is extracted and corrected by visual inspection performed by a user. However, extraction of the defect or the deficiency included in the design diagram by visual inspection need a large number of man-hours, and insufficient extraction or erroneous extraction may occur in some cases. In particular, in a design diagram or the like of a large-scale system, such as a plant, the amount of information is large and the design diagram is complicated; therefore, extraction of a defect or a deficiency by visual inspection needs a huge number of man-hours and a huge amount of operation, so that mistakes are likely to occur.

Japanese Laid-open Patent Publication No. 2022-080793 describes, as a technology for extracting a defect or a deficiency, a technology for selecting a reference component group from among component groups that include a plurality of components, searching for a plurality of different component groups that are included in the design diagram, and extracting a component group that includes a different portion from the reference component group. For example, in this technology, when a user performs verification, proofreading, editing, modification, or the like on the design diagram, a component group for which setting information on a component that is selected by the user is the same or partly different is extracted to improve operation efficiency and quality of the diagram.

### SUMMARY

It is an object of the present invention to at least partially solve the problems in the conventional technology.

According to an aspect of the embodiments, a diagram analysis apparatus includes a processor configured to extract, from a design diagram of a plant, components of the design diagram, and identify a setting position of setting information corresponding to an identification condition in the design diagram or a setting detail of the setting information in the design diagram or any combination thereof, based on the components of the design diagram.

### BRIEF DESCRIPTION OF THE DRAWINGS

FIG. 1 is a diagram for explaining a diagram analysis process according to one embodiment;

FIG. 2 is a diagram illustrating an example of a problem with a reference technology;

FIG. 3 is a diagram for explaining a diagram analysis process according to a first embodiment;

FIG. 4 is a diagram illustrating an example of a configuration of a diagram analysis apparatus according to the first embodiment;

FIG. 5 is a diagram illustrating an example of a design diagram according to the first embodiment;

FIG. 6 is a table diagram illustrating an example of identification conditions according to the first embodiment;

FIG. 7 is a table diagram illustrating an example of extracted components according to the first embodiment;

FIG. 8 is a table diagram illustrating an example of candidate defective diagram portions according to the first embodiment;

FIG. 9 is a flowchart illustrating the flow of the diagram analysis process according to the first embodiment;

FIG. 10 is a diagram illustrating an example of the diagram analysis process according to the first embodiment;

FIG. 11 is a diagram illustrating an example of the diagram analysis process according to the first embodiment;

FIG. 12 is a diagram illustrating an example of the diagram analysis process according to the first embodiment;

FIG. 13 is a diagram illustrating an example of the diagram analysis process according to the first embodiment;

FIG. 14 is a diagram illustrating an example of the diagram analysis process according to the first embodiment;

FIG. 15 is a diagram for explaining a diagram analysis process according to a second embodiment;

FIG. 16 is a table diagram illustrating an example of identification conditions according to the second embodiment;

FIG. 17 is a diagram illustrating an example of the diagram analysis process according to the second embodiment;

FIG. 18 is a flowchart illustrating the flow of the diagram analysis process according to the second embodiment; and

FIG. 19 is a hardware configuration diagram illustrating an example of a computer that implements functions of the diagram analysis apparatus according to one embodiment.

### DESCRIPTION OF THE EMBODIMENT

In terms of improvement in the quality of the design diagram, there is room for improvement in the technology as described above. For example, in the design diagram, such as a P&ID, in some cases, needed information is not written or erroneous description is included, which is a defect or a deficiency other than the defect or the deficiency described in the related art. When the defect or the deficiency as described above is included, the design diagram may be differently interpreted depending on a user who refers to the diagram, which may lead to a big problem. Therefore, to prevent different interpretation depending on a user, a user needs to detect a defect or a deficiency and correct the defect or the deficiency by visual inspection on the design diagram. However, manual detection of a defect or a deficiency as described above need a huge number of man-hours or a huge amount of operation, and insufficient detection of a defect or a deficiency is likely to occur, so that it is difficult to improve quality of the design diagram.

Embodiments of a diagram analysis apparatus, a diagram analysis method, and a diagram analysis program according to the present invention will be described in detail below with reference to the drawings. The present invention is not limited by the embodiments described below.

### Description of Diagram Analysis Apparatus

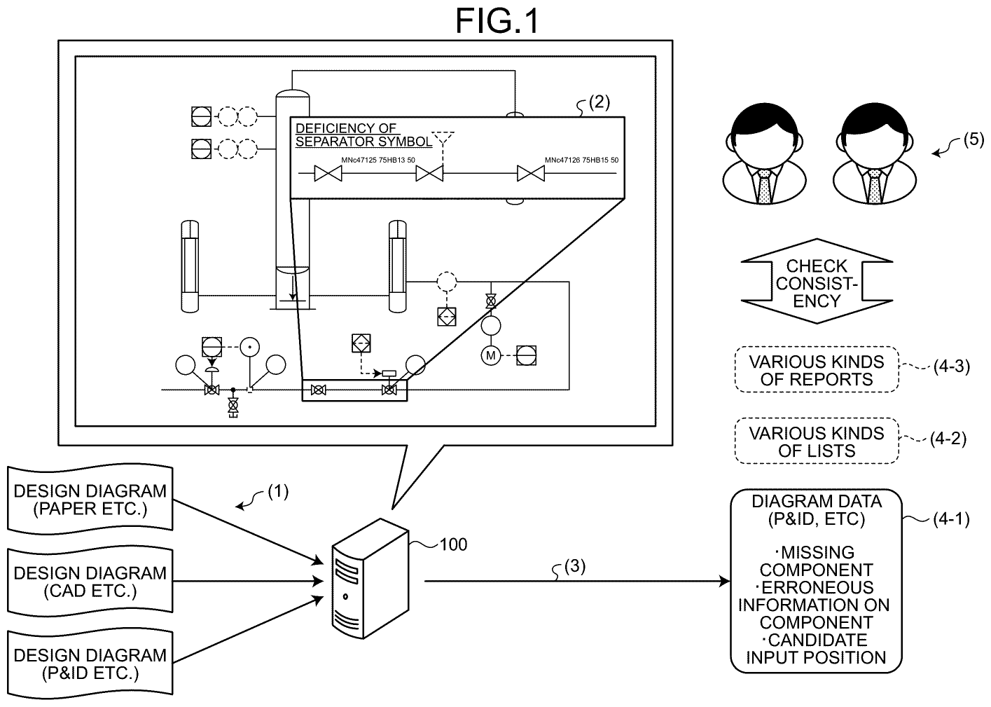

FIG. 1 is a diagram for explaining a diagram analysis process according to one embodiment. A diagram analysis apparatus 100 illustrated in FIG. 1 is one example of a computer that provides a technology for receiving input of design diagram data (hereinafter, may be simply described as a “design diagram”) on a digitized plant or the like, and identifying a deficiency of a piping separator symbol, a deficiency of piping identification information, a deficiency of a fluid flow direction symbol, a candidate input position, or the like from the input design diagram.

In general, the design diagram, such as a P&ID, in a plant is a design drawing that defines components, such as equipment, parts, and piping to be used, a combination of the components, fluid flow directions in piping, and the like. The design diagram needs to be unique information to enable a plurality of users to perform operation, such as engineering, assembly, or setting, from information on a single design diagram. Therefore, in recent years, a digitized design diagram is generated based on Computer-Aided Design (CAD) or the like.

The design diagram may be differently interpreted depending on a user who refers to the design diagram if information is insufficient due to insufficient recognition, insufficient description, or the like of a creator of the design diagram. For example, when a plurality of designers generate a design diagram, insufficient description or inconsistent description may occur due to insufficient recognition of design details among the designers.

In particular, in case of a complicated design diagram that includes a large amount of information, insufficient description or erroneous description is likely to occur. Further, even when a designer searches for the insufficient description or the erroneous description and performs correction or the like, it is likely that a large amount of time and effort may be needed or insufficient correction operation or erroneous correction operation may be performed. As a result, in case of a complicated design diagram that includes a large amount of information, insufficient detection, insufficient correction, or the like is likely to occur.

Insufficient information or inconsistent notation in the design diagram as described above leads to a situation in which each of users who are involved in plant design is prevented from uniquely interpreting the design diagram, and leads to reduction of quality of a plant or a structure that is manufactured, assembled, and constructed based on the design diagram or a delay of processes at the time of construction, which is a critical issue.

To cope with this, even for a design diagram of a plant that includes a large amount of information, a user needs to visually detect a deficiency, such as a deficiency in which single interpretation is impossible with respect to various kinds of information described in the design diagram, and add a description or correct the deficiency in order to prevent occurrence of the deficiency. However, visual operation performed by the user includes operation of checking components with similar notations one by one and extracting errors, and needs a large number of man-hours and a large amount of time and efforts, which is not realistic operation.

In view of the above, a reference technology for selecting a reference component group from among component groups that include a plurality of components in a design diagram, searching for different component groups that are included in the design diagram, and extracting a component group that includes a different portion from the reference component group is known.

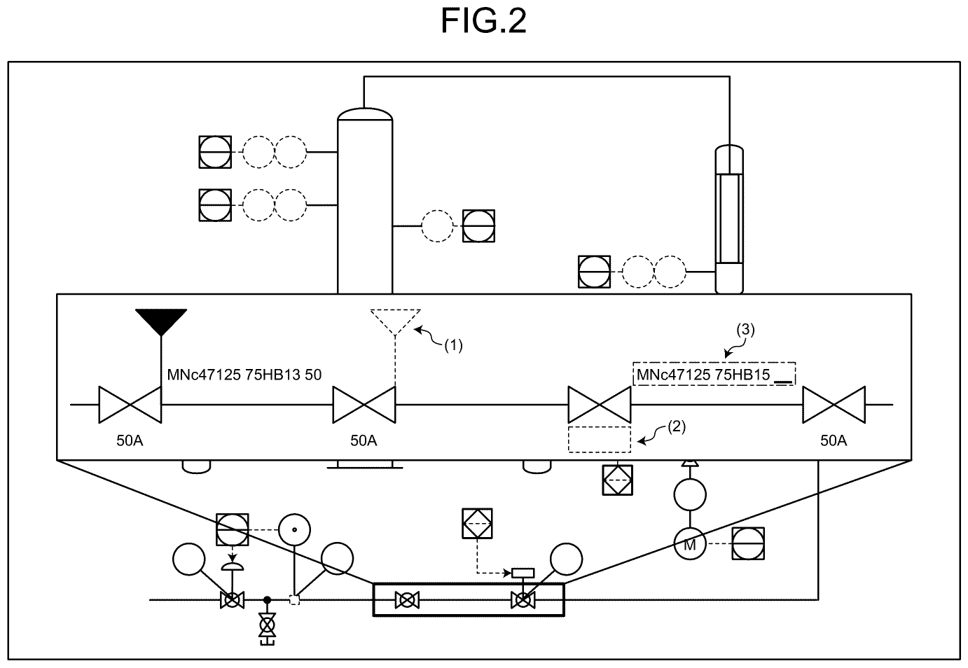

However, in the reference technology, in some cases, it is difficult to extract a deficiency in the design diagram. FIG. 2 is a diagram illustrating an example of a problem with the reference technology. As illustrated in FIG. 2, the reference technology extracts only the same component or a partly different component between a reference component and a comparison target component, and it is impossible to extract a component group that includes a deficiency or a defect unless specifying the reference component.

Specifically, the reference technology is a technology for extracting a component group that includes a difference by comparison with a component group that is selected and specified by a user, and it is difficult to identify a deficiency in a design diagram other than the component group that is specified as the reference. For example, as indicated by (1) in FIG. 2, in the reference technology, it is difficult to identify a lack of a separator symbol at a piping switching position. Further, as indicated by (2) in FIG. 2, in the reference technology, it is difficult to identify a lack of size information on a valve, such as “50A”, that needs to be input in the vicinity of a valve pipe. Furthermore, for example, as indicated by (3) in FIG. 2, in the reference technology, when piping identification information includes erroneous description, it is difficult to recognize and identify the erroneous description in the piping identification information.

To cope with this, the diagram analysis apparatus 100 according to the present embodiment extracts, from a design diagram of a plant, components of the design diagram. Further, the diagram analysis apparatus 100 identifies at least one of a setting position of setting information corresponding to an identification condition in the design diagram and a setting detail of the setting information, based on the components in the design diagram.

Specific explanation will be given below with reference to FIG. 1. As indicated by (1) in FIG. 1, the diagram analysis apparatus 100 analyzes a design diagram of a plant, such as a paper design diagram or a design diagram including a P&Id that is designed by CAD or the like.

Subsequently, the diagram analysis apparatus 100 extracts, from the design diagram of the plant, components, such as equipment, instruments, piping parts, piping, piping identification information, and fluid flow directions in piping, of the design diagram. Thereafter, as indicated by (2) in FIG. 1, the diagram analysis apparatus 100 identifies a setting position of setting information corresponding to an identification condition, such as a deficiency of a piping separator symbol, a deficiency of piping identification information, a deficiency of a fluid flow direction symbol, or a candidate input position of a component, or identifies a setting detail of the setting information, based on the extracted information.

Thereafter, as indicated by (3) in FIG. 1, the diagram analysis apparatus 100 displays the setting position of the setting information corresponding to the identification condition or the setting detail of the setting information to the user in a superimposed manner on the design diagram. For example, the diagram analysis apparatus 100 displays information, such as a “missing component”, “erroneous information on component”, or a “candidate input position”, on the design diagram, such as a P&ID, in a superimposed manner ((4-1) in FIG. 1). Meanwhile, the diagram analysis apparatus 100 is able to output various kinds of lists ((4-2) in FIG. 1), such as a component list or a spreadsheet of materials, of the design diagram or various kinds of reports ((4-3) in FIG. 1) in which consistency of the design diagram is summarized.

Further, the user checks consistency based on the displayed information ((5) in FIG. 1). Therefore, the diagram analysis apparatus 100 is able to simplify checking of consistency of the design diagram and improve quality of the design diagram.

Meanwhile, the “component” as described above includes piping, a valve, piping identification information, and a piping separator symbol (hereinafter, may be simply described as a “separator symbol”) that are extracted from the design diagram by the diagram analysis apparatus. Further, the “setting position of setting information corresponding to an identification condition or setting detail of setting information (hereinafter, may be described as a “defective diagram portion”)” includes a deficiency of a piping separator symbol, a deficiency of piping identification information, and a deficiency of a fluid flow direction symbol or a candidate input position of a component among piping, valves, piping identification information, separator symbols, and symbols indicating the fluid flow directions in the piping as described above. Furthermore, the “setting information” includes attribute information, such as a material, a shape, a type of equipment or a part, or a fluid flow direction, which is assigned to a component of the design diagram. Moreover, the “piping identification information” may include attribute information, such as a material or a size, of piping, in addition to a character string for identifying the piping.

### First Embodiment

### Description of Diagram Analysis Apparatus 100

An example will be described in which the diagram analysis apparatus 100 according to the first embodiment identifies and outputs, as the defective diagram portion, a deficiency of a piping separator symbol, a deficiency of piping identification information, a deficiency of a fluid flow direction symbol, or the like based on design diagram components that are extracted from the design diagram.

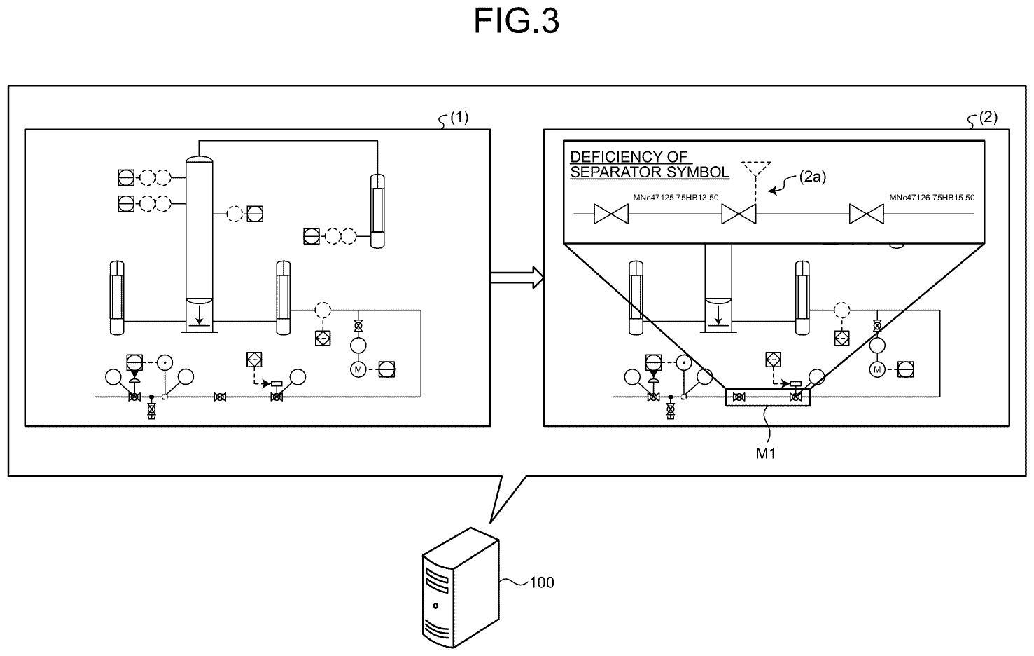

First, a process performed by the diagram analysis apparatus 100 according to the first embodiment will be described. FIG. 3 is a diagram for explaining a diagram analysis process according to the first embodiment.

For example, the diagram analysis apparatus 100 identifies, in a design diagram, a deficiency of a piping separator symbol, such as missing of a separator symbol, based on design diagram components, such as “piping included in the design diagram, piping identification information, a separator symbol, a symbol that represents a valve, a pump, or the like”. Similarly, the diagram analysis apparatus 100 identifies, in the design diagram, a deficiency of piping identification information, such as missing of the piping identification information or erroneous description. Further, the diagram analysis apparatus 100 identifies, in the design diagram, a deficiency of a fluid flow direction symbol, such as a cause of contradiction of fluid flow directions in the piping.

As one example, as illustrated in FIG. 3, the diagram analysis apparatus 100 extracts design diagram components from the design diagram ((1) in FIG. 3). Subsequently, the diagram analysis apparatus 100 identifies a component group M1 ((2) in FIG. 3) that corresponds to a deficiency of a piping separator symbol, a deficiency of piping identification information, a deficiency of a fluid flow direction symbol, or the like in the design diagram, based on the extracted design diagram components. For example, the diagram analysis apparatus 100 identifies a design diagram on which a “deficiency of a piping separator symbol ((2a) in FIG. 3)” is superimposed.

In this manner, the diagram analysis apparatus 100 identifies a defective diagram portion that can hardly be detected visually by a human being in a complicated design diagram which includes a large amount of information and in which insufficient extraction, insufficient correction, erroneous correction, or the like is likely to occur.

### Configuration of Diagram Analysis Apparatus

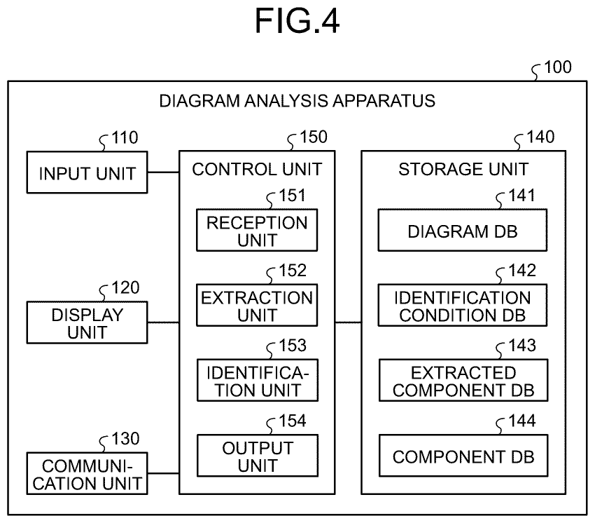

A configuration of the diagram analysis apparatus 100 according to the first embodiment will be described below. FIG. 4 is a diagram illustrating an example of the configuration of the diagram analysis apparatus 100 according to the first embodiment. As illustrated in FIG. 4, the diagram analysis apparatus 100 includes an input unit 110, a display unit 120, a communication unit 130, a storage unit 140, and a control unit 150.

### Input Unit 110

The input unit 110 controls input of various kinds of information to the diagram analysis apparatus 100. For example, the input unit 110 is implemented by a mouse, a keyboard, or the like, and receives input of setting information, information on a design diagram, or the like to the diagram analysis apparatus 100.

### Display Unit 120

The display unit 120 controls display of various kinds of information from the diagram analysis apparatus 100. For example, the display unit 120 displays a “deficiency of a piping separator symbol”, a “deficiency of piping identification information”, a “deficiency of a fluid flow direction symbol”, or the like that is identified by the control unit 150 (to be described later) to a user who performs modification, editing, creation, or the like of a design diagram. Meanwhile, the display unit 120 may be implemented by a display or the like.

### Communication Unit 130

The communication unit 130 controls data communication with a different apparatus via a router or the like. For example, the communication unit 130 outputs, by data communication, a “deficiency of a piping separator symbol”, a “deficiency of piping identification information”, a “deficiency of a fluid flow direction symbol”, or the like that is identified by the control unit 150 (to be described later) to a terminal apparatus or the like that is operated by the above-described user. Meanwhile, the communication unit 130 may be implemented by a network interface card or the like.

### Storage Unit 140

The storage unit 140 stores therein various kinds of information to be referred to when the control unit 150 (to be described later) operates, and various kinds of information that are acquired when the control unit 150 operates. The storage unit 140 includes a diagram DB 141, an identification condition DB 142, an extracted component DB 143, and a component DB 144. Here, the storage unit 140 may be implemented by, for example, a semiconductor memory device, such as a Random Access Memory (RAM) or a flash memory, a storage device, such as a hard disk or an optical disk, or the like.

### Diagram DB 141

The diagram DB 141 is a database for storing information on a design diagram. Specifically, the diagram DB 141 stores therein, as the information on the design diagram, a digitized design diagram, a list related to the design diagram, a functional structural drawing of a design target related to the design diagram, or the like.

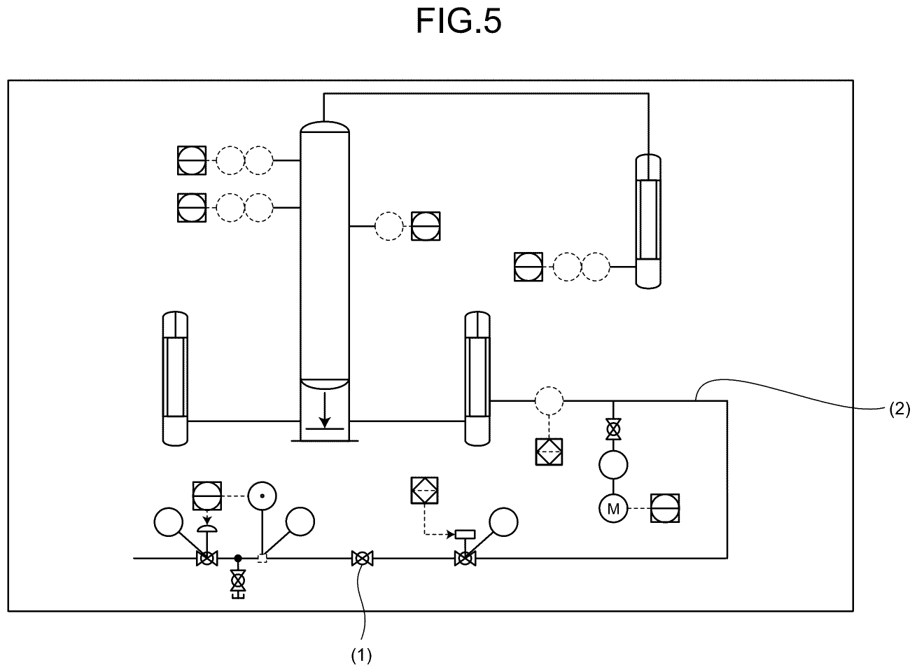

An example of the information on the design diagram stored in the diagram DB 141 will be described below. FIG. 5 is a diagram illustrating an example of a design diagram according to the first embodiment. The design diagram illustrated in FIG. 5 is technical information that represents a structure and a design of a facility, such as a plant, in accordance with a predetermined scale by using a drawing or a line diagram. For example, the design diagram illustrated in FIG. 5 includes a valve ((1) in FIG. 5) and piping ((2) in FIG. 5) as components.

In this manner, the diagram DB 141 stores therein the design diagram as a digitized design diagram, such as image data, Portable Document Format (PDF) data, CAD data, or P&ID data.

Further, although not illustrated in the drawing, the diagram DB 141 may store therein, as the information on the design diagram, list data that represents design diagram components in the form of a list and a functional structural drawing that represents the design diagram components as structural information.

### Identification Condition DB 142

The identification condition DB 142 is a database for storing a condition (hereinafter, may be simply described as an “identification condition”) that is used by an identification unit 153 (to be described later) to identify a defective diagram portion based on extracted design diagram components. Specifically, the identification condition DB 142 stores therein a condition for identifying, from among the design diagram components, a “deficiency of a piping separator symbol”, a “deficiency of piping identification information”, a “deficiency of a fluid flow direction symbol”, or the like.

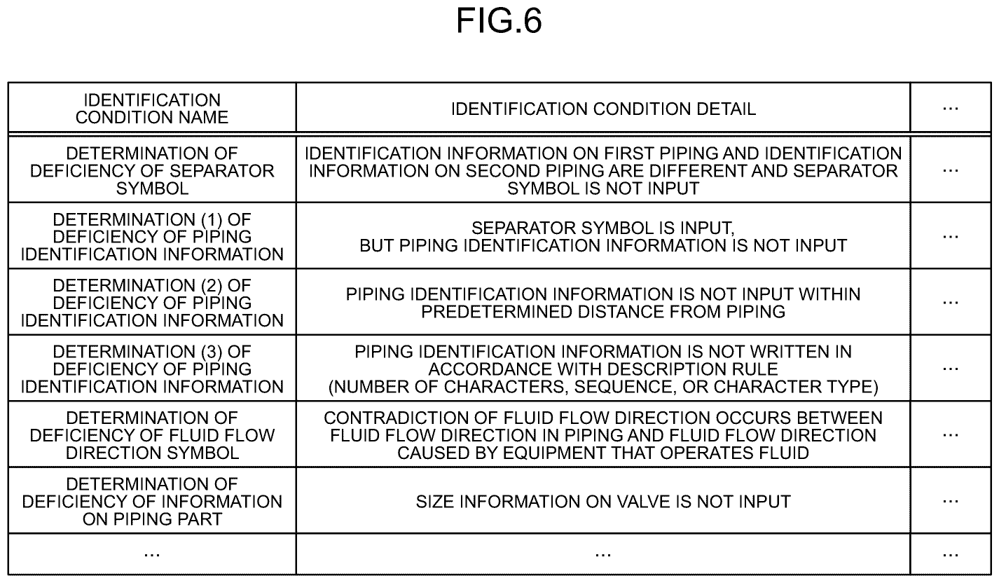

FIG. 6 is a table diagram illustrating an example of identification conditions according to the first embodiment. As illustrated in FIG. 6, the identification condition DB 142 stores therein, as an identification condition, an “identification condition name” and an “identification condition detail” in an associated manner. Here, the identification condition name is identification information for identifying the identification condition, and may be a text that is written by natural language, a character string based on a predetermined rule, or the like. Further, the identification condition detail is information in which a condition that the identification unit 153 uses for the identification process is written. An example of each of the identification conditions will be described below.

For example, the identification condition DB 142 stores therein an identification condition name of “determination of deficiency of separator symbol” and an identification condition detail of “identification information on first piping and identification information on second piping are different and separator symbol is not input” in an associated manner. In other words, the identification condition DB 142 stores therein a condition for identifying a state in which the piping identification information is input, but a “separator symbol” that indicates a switching position of the piping is not input, as a “deficiency of separator symbol”.

For example, the identification condition DB 142 stores therein an identification condition name of “determination (1) of deficiency of piping identification information” and an identification condition detail of “separator symbol is input, but piping identification information is not input” in an associated manner. In other words, the identification condition DB 142 stores therein a condition for identifying a state in which a “separator symbol” that indicates a switching position of piping is input, but at least one of the identification information on the first piping and the identification information on the second piping is absent, as a “deficiency of piping identification information”.

For example, the identification condition DB 142 stores therein an identification condition name of “determination (2) of deficiency of piping identification information” and an identification condition detail of “piping identification information is not input within a predetermined distance from piping” in an associated manner. In other words, the identification condition DB 142 stores therein a condition for identifying a state in which the piping identification information is not input or the piping identification information is not input within a predetermined distance, such that an input position is too far, as a “deficiency of piping identification information”.

For example, the identification condition DB 142 stores therein an identification condition name of “determination (3) of deficiency of piping identification information” and an identification condition detail of “piping identification information is not written in accordance with a description rule (number of characters, sequence, or character type)” in an associated manner. In other words, the identification condition DB 142 stores therein a condition for identifying a state in which the piping identification information is input but does not comply with a description rule, as a “deficiency of piping identification information”. The “number of characters” described herein is a condition for determining whether the number of characters describing the identification information is excessive or deficient. Further, the sequence is a condition for determining whether a character string describing the identification information complies with the rule. Furthermore, the character type is a condition for determining whether a type of characters describing the identification information complies with the rule. For example, in the first embodiment, the description rule includes “two uppercase letters, one lowercase alphabet, five numerals, a space, two numerals, two uppercase alphabets, two numerals, a space, two numeral”, or the like.

For example, the identification condition DB 142 stores therein an identification condition name of “determination of deficiency of fluid flow direction symbol” and an identification condition detail of “contradiction of fluid flow direction occurs between fluid flow direction in piping and fluid flow direction caused by equipment that operates fluid” in an associated manner. In other words, the identification condition DB 142 stores therein a condition for identifying that there is a “deficiency of fluid flow direction symbol” because a symbol that represents a fluid flow direction in piping is described with respect to the piping, but a contradiction occurs with a fluid flow direction caused by a different component, such as a pump.

For example, the identification condition DB 142 stores therein an identification condition name of “determination of deficiency of information on piping part” and an identification condition detail of “size information on valve is not input” in an associated manner. In other words, the identification condition DB 142 stores therein a condition for identifying a state in which size information on a valve is not input or the size information on the valve is not input within a predetermined distance, such that an input position is too far, as a “deficiency of size information on valve”.

### Extracted Component DB 143

The extracted component DB 143 is a database in which extracted design diagram components are stored by an extraction unit 152 (to be described later). For example, the extracted component DB 143 stores therein, as the design diagram components, piping, piping identification information, a separator symbol, a symbol that represents a valve or a pump, and the like that are included in the design diagram and that are extracted from the design diagram, in association with a component category.

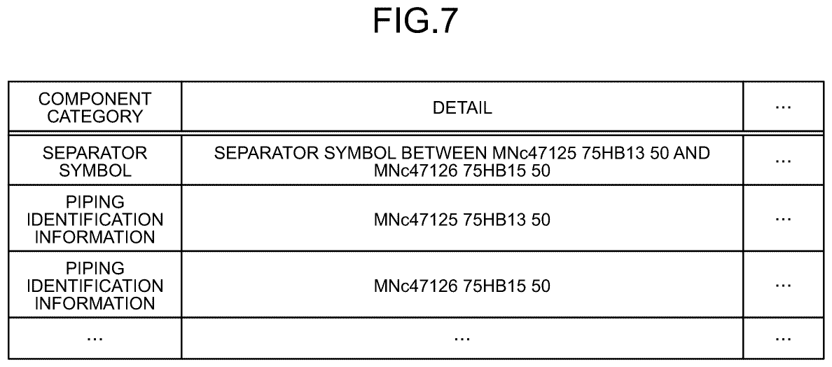

FIG. 7 is a table diagram illustrating an example of extracted components according to the first embodiment. As illustrated in FIG. 7, the extracted component DB 143 stores therein, as the extracted design diagram component, a “component category”, a “detail”, and the like. The component category described herein is information for classifying an extracted component. As one example, the component category includes information indicating a symbol corresponding to the extracted component and an input position of the symbol in the design diagram, or information indicating setting information, such as piping identification information.

For example, the extracted component DB 143 stores therein a component category of “separator symbol” and a detail of a “separator symbol between MNc47125 75HB13 50 and MNc47126 75HB15 50” in an associated manner. In other words, the extracted component DB 143 identifies and stores a separator symbol that is described between piping of “MNc47125 75HB13 50” and piping of “MNc47126 75HB15 50”.

Further, the extracted component DB 143 stores therein a component category of “piping identification information” and a detail of “MNc47125 75HB13 50” in an associated manner. Furthermore, the extracted component DB 143 stores therein a component category of “piping identification information” and a detail of “MNc47126 75HB15 50” in an associated manner. In other words, the extracted component DB 143 identifies and stores each of piping of “MNc47125 75HB13 50” and piping of “MNc47126 75HB15 50” included in the design diagram.

### Component DB 144

The component DB 144 is a database for storing information on a defective diagram portion, such as a “deficiency of a piping separator symbol”, a “deficiency of piping identification information”, or a “deficiency of a fluid flow direction symbol”, which is identified by the identification unit 153 (to be described later). Specifically, the component DB 144 stores therein a detail and a state identified by the identification unit 153 in association with the component category.

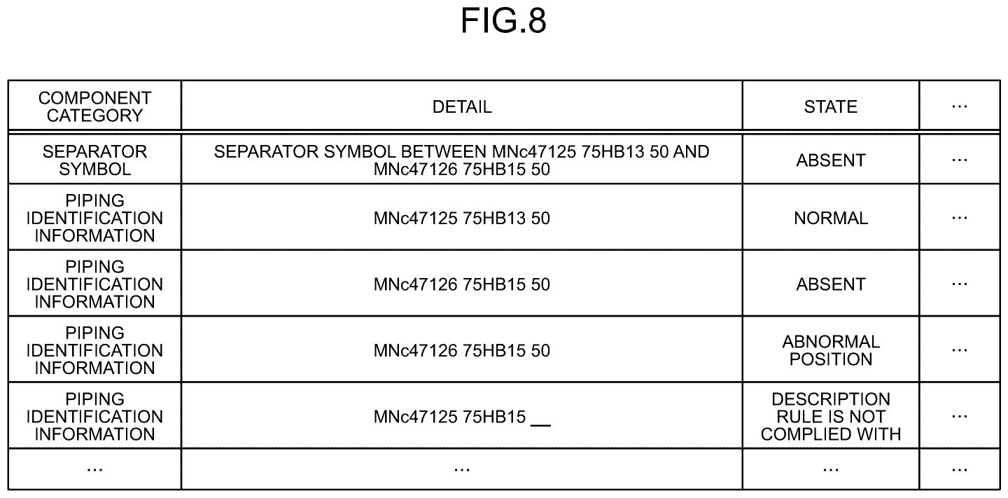

FIG. 8 is a table diagram illustrating an example of candidate defective diagram portions according to the first embodiment. As illustrated in FIG. 8, the component DB 144 stores therein, as the information on the defective diagram portion as described above, a “component category”, a “detail”, a “state”, and the like. The component category described herein is information for classifying a defective diagram portion. Further, the detail is information for identifying a “piping separator symbol” piping identification information”, or the like. Furthermore, the state is information indicating whether a deficiency is included or a detail of the deficiency if the deficiency is included.

For example, the component DB 144 stores therein a component category of “separator symbol”, a detail of a “separator symbol between MNc47125 75HB13 50 and MNc47126 75HB15 50”, and a state of “absent” in an associated manner. In other words, the component DB 144 stores therein information indicating that a separator symbol that is input between the piping identification information of “MNc47125 75HB13 50” and the identification information of the piping of “MNc47126 75HB15 50” is absent.

For example, the component DB 144 stores therein a component category of “piping identification information”, a detail of “MNc47125 75HB13 50”, and a state of “normal” in an associated manner. In other words, the component DB 144 stores therein information indicating that the piping identification information of “MNc47125 75HB13 50” is normally input.

For example, the component DB 144 stores therein a component category of “piping identification information”, a detail of “MNc47126 75HB15 50”, and a state of “absent” in an associated manner. In other words, the component DB 144 stores therein information indicating that the piping identification information of “MNc47126 75HB15 50” is absent.

For example, the component DB 144 stores therein a component category of “piping identification information”, a detail of “MNc47126 75HB15 50”, and a state of an “abnormal position” in an associated manner. In other words, the component DB 144 stores therein information indicating that the piping identification information of “MNc47126 75HB15 50” is present, but is not located at a predetermined position.

For example, the component DB 144 stores therein a component category of “piping identification information”, a detail of “MNc47125 75HB15”, and a state of “description rule is not complied with” in an associated manner. In other words, the component DB 144 stores therein information indicating that the piping identification information of “MNc47125 75HB15” is described against the description rule that is set in advance.

### Control Unit 150

Referring back to FIG. 4, explanation will be continued. The control unit 150 controls the entire diagram analysis apparatus 100. The control unit 150 includes a reception unit 151, the extraction unit 152, the identification unit 153, and an output unit 154. The control unit 150 may be implemented by, for example, an electronic circuit, such as a Central Processing Unit (CPU) or a Micro Processing Unit (MPU), or an integrated circuit, such as an Application Specific Integrated Circuit (ASIC) or a Field Programmable Gate Array (FPGA).

### Reception Unit 151

The reception unit 151 receives predetermined information that is used for a diagram analysis process. Specifically, the reception unit 151 receives the information on the design diagram, which is input via the input unit 110. Further, the reception unit 151 stores the received information on the design diagram in the diagram DB 141. The information on the design diagram may be a design diagram that is obtained by digitizing a paper design diagram based on an image analysis or the like, or information on a design diagram, such as a P&ID, that is designed by a computer based on CAD or the like, for example.

### Extraction Unit 152

The extraction unit 152 extracts, from the design diagram that is received as the information on the design diagram by the reception unit 151, various kinds of information described in the design diagram by performing a process, such as image analysis, character recognition, or symbol recognition. Specifically, the extraction unit 152 extracts, as a design diagram component from the design diagram of the plant, piping, piping identification information, a separator symbol, a symbol that represents a valve or a pump, or the like included in the design diagram. Further, the extraction unit 152 stores the extracted information in the extracted component DB 143.

For example, the extraction unit 152 recognizes the design diagram, components included in the design diagram, and connections between the components based on pattern matching, and extracts the design diagram components. Furthermore, the extraction unit 152 performs an image recognition process on the design diagram to recognize an outer shape or a form, and extracts the design diagram components. Moreover, the extraction unit 152 recognizes details of the components based on a meaning model, a graph theory, ontology, or the like, and extracts the design diagram components.

Furthermore, the extraction unit 152 recognizes components in the design diagram based on a notation rule that is registered in advance for each design diagram, and extracts the design diagram components. The notation rule described herein is a predetermined rule, such as “a valve is represented by a symbol ∘∘”, “piping is represented by a black bold line”, or “a separator symbol is represented by a symbol ●●”, for example.

### Identification Unit 153

The identification unit 153 identifies a setting position of setting information corresponding to an identification condition or a setting detail of the setting information stored in the identification condition DB 142, based on the design diagram components extracted by the extraction unit 152. Meanwhile, it may be possible to use all of the identification conditions or only an identification condition designated by a user, that is, it is possible to appropriately set an identification condition to be used.

Meanwhile, details of a method of identifying the setting position of the setting information corresponding to the identification condition or the setting detail of the setting information will be described later; however, an identification method performed by the identification unit 153 will be briefly described below by using the identification conditions illustrated in FIG. 6.

For example, the identification unit 153 identifies a setting position of a separator symbol or the like corresponding to the identification condition detail that is associated with the identification condition of “determination of deficiency of separator symbol” in FIG. 6. Specifically, the identification unit 153 identifies, from the design diagram, whether a needed separator symbol is input and an input target position or the like of the separator symbol.

Furthermore, the identification unit 153 identifies a setting position of piping identification information or the like corresponding to the identification condition detail that is associated with the identification condition of “determination (1) of deficiency of piping identification information” in FIG. 6. Specifically, the identification unit 153 identifies, from the design diagram, whether needed piping identification information is input and an input target position or the like of absent piping identification information.

Moreover, the identification unit 153 identifies a setting position of piping identification information or the like corresponding to the identification condition detail that is associated with the identification condition of “determination (2) of deficiency of piping identification information” in FIG. 6. Specifically, the identification unit 153 identifies, from the design diagram, whether the piping identification information is input at a correct position, an input target position, or the like.

Furthermore, the identification unit 153 identifies a setting detail of piping identification information corresponding to the identification condition detail that is associated with the identification condition of “determination (3) of deficiency of piping identification information” in FIG. 6. Specifically, the identification unit 153 identifies, from the design diagram, whether piping identification information or the like that does not comply with the description rule is input.

Moreover, the identification unit 153 identifies a setting detail or a setting position of a symbol or the like corresponding to the identification condition detail that is associated with the identification condition of “determination of deficiency of fluid flow direction symbol” in FIG. 6. Specifically, the identification unit 153 identifies a contradictory portion of a fluid flow direction between a fluid flow direction in piping that is identified by the setting information that is set in the design diagram and a fluid flow direction caused by equipment that operates a fluid that is identified by the setting information, and identifies a position at which the identified contradiction occurs or a portion or the like that causes the contradiction.

Furthermore, the identification unit 153 identifies a setting position of information or the like of a piping part corresponding to the identification condition detail that is associated with the identification condition of “determination of deficiency of information on piping part” in FIG. 6. Specifically, the identification unit 153 identifies, from the design diagram, whether needed information on a piping part is input, an input target position, or the like.

### Output Unit 154

The output unit 154 outputs the defective diagram portion that is identified by the identification unit 153, in a predetermined format. Specifically, the output unit 154 outputs, to the display unit 120, a design diagram that is displayed in a highlighted manner that allows a user to visually understand the defective diagram portions corresponding to the identification conditions in FIG. 6. Further, the output unit 154 outputs the design diagram that is displayed in a highlighted manner that enables understanding as described above to a terminal apparatus or the like of the user via the communication unit 130.

For example, the output unit 154 outputs a design diagram that is displayed in a highlighted manner in a certain format such that a deficiency of a piping separator symbol, a deficiency of piping identification information, a deficiency of a fluid flow direction symbol, or peripheral portions of the above-described deficiencies are surrounded by frames, a format, such as a background color, font, or a text color, of the corresponding components is changed, or the corresponding defective diagram portions are blinked.

### Flow of Diagram Analysis Process

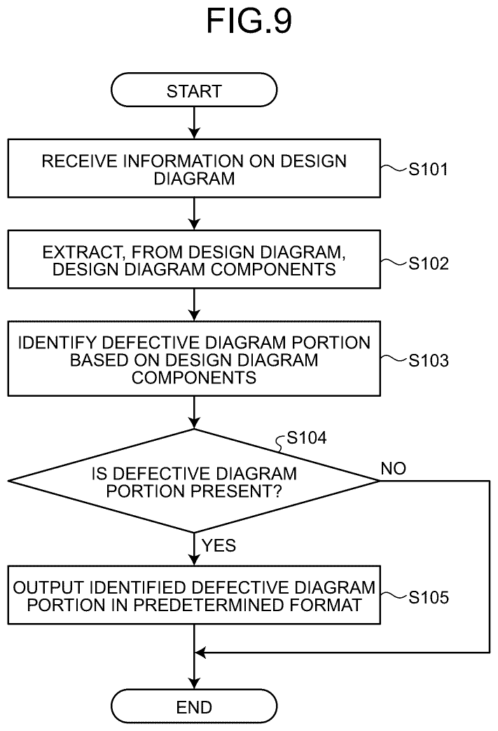

A flow of the diagram analysis process according to the first embodiment will be described below. FIG. 9 is a flowchart illustrating the flow of the diagram analysis process according to the first embodiment. Steps described below may be performed in different order as long as not contradiction is derived, or any process may be omitted.

As illustrated in FIG. 9, the reception unit 151 receives information on a design diagram that is obtained by digitizing a paper design diagram based on an image analysis or the like, or information on a design diagram that is designed by a computer based on CAD or the like (S101).

The extraction unit 152 extracts, from the design diagram, design diagram components, such as piping, piping identification information, and a separator symbol, by using an algorithm or the like for pattern matching, an image recognition process, or the like (S102).

The identification unit 153 identifies, based on the design diagram components, a defective diagram portion corresponding to a deficient separator symbol, deficient piping identification information, piping identification information including erroneous description, a position at which contradiction of a fluid flow direction occurs, or the like (S103).

Here, if the identification unit 153 does not identify the defective diagram portion (No at S104), the diagram analysis apparatus 100 terminates the process. In contrast, if the identification unit 153 identifies the defective diagram portion (Yes at S104), the output unit 154 outputs the identified defective diagram portion in a predetermined format (S105). Then, the diagram analysis apparatus 100 terminates the process.

### Example of Diagram Analysis Process

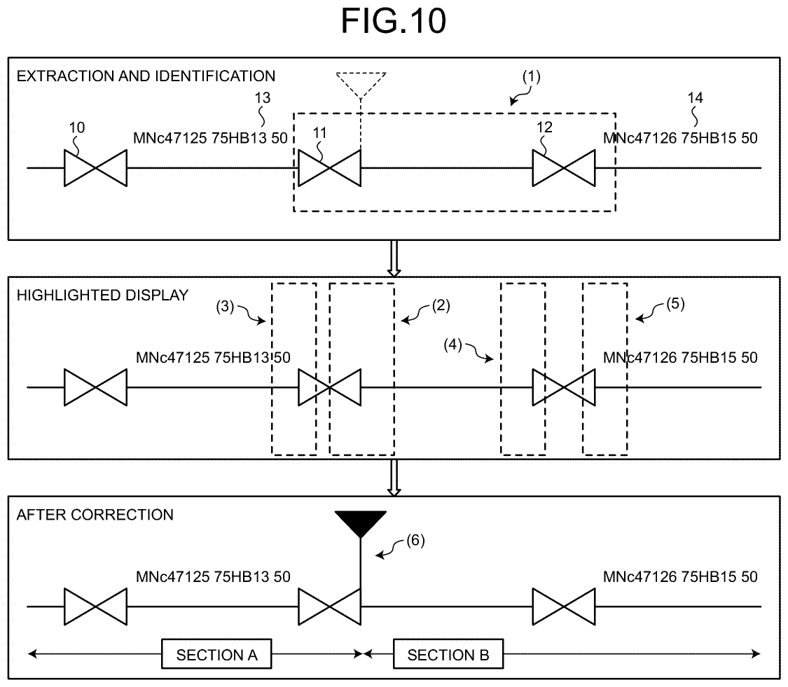

A specific example in which the diagram analysis apparatus 100 identifies a deficiency of a design diagram by using each of the identification conditions described above with reference to FIG. 6 will be described below. FIG. 10 to FIG. 14 are diagrams illustrating examples of the diagram analysis process according to the first embodiment.

### Identification of Deficient Separator Symbol

A specific example using the identification condition of “determination of deficiency of separator symbol” illustrated in FIG. 6 will be described below with reference to FIG. 10. As one example, explanation will be given of a case in which the diagram analysis apparatus 100 identifies insufficient input of a separator symbol that indicates a separation position between piping and piping. FIG. 10 illustrates an example in which an input missing position of a separator symbol is identified from a design diagram in which a needed separator symbol is not input at a piping separation position, and the input missing position is displayed in a highlighted manner on the design diagram.

First, an “extraction and identification” step illustrated in FIG. 10 will be described. The diagram analysis apparatus 100 extracts, from the received design diagram, piping, valves 10 to 12, piping identification information 13 (MNc47125 75HB13 50), and piping identification information 14 (MNc47126 75HB15 50). Meanwhile, the diagram analysis apparatus 100 is able to extract the design diagram components without any limitation on extraction order without.

Further, the diagram analysis apparatus 100 extracts a structure in which piping that is identified by the piping identification information 13 (MNc47125 75HB13 50) is connected to a right portion of the valve 10 and a left portion of the valve 11, and piping that is identified by the piping identification information 14 (MNc47126 75HB15 50) is connected from a right portion of the valve 11 to a left portion of the valve 12 and from a right portion of the valve 12.

Subsequently, the diagram analysis apparatus 100 recognizes that a piping separation position is located in a range indicated by (1) in FIG. 10 because piping attributes that are set in the piping identified by the extracted piping identification information 13 (MNc47125 75HB13 50) and the piping identified by the piping identification information 14 (MNc47126 75HB15 50) are different. However, a separator symbol that needs to be present in the recognized range is not included in the extracted components, and therefore, the diagram analysis apparatus 100 identifies that a separator symbol is missing at the separation position.

A “highlighted display” step illustrated in FIG. 10 will be described below. The diagram analysis apparatus 100 outputs a design diagram in which candidate positions of the identified missing separator symbol are displayed in a highlighted manner by being enclosed in dashed frames as indicated by (2) to (5) in FIG. 10, for example.

Thereafter, as indicated by an “after correction” step in FIG. 10, the diagram analysis apparatus 100 receives input of a separator symbol from a user with respect to a position that is selected by the user from among the candidate positions that are displayed in a highlighted manner. Further, as indicated by (6) in FIG. 10, the diagram analysis apparatus 100 updates the originally received design diagram with a design diagram in which a missing separator symbol is input. As a result, it becomes possible to uniquely identify a “section A” and a “section B” by adopting the selected position as the separation position.

### Identification of Deficient Piping Identification Information

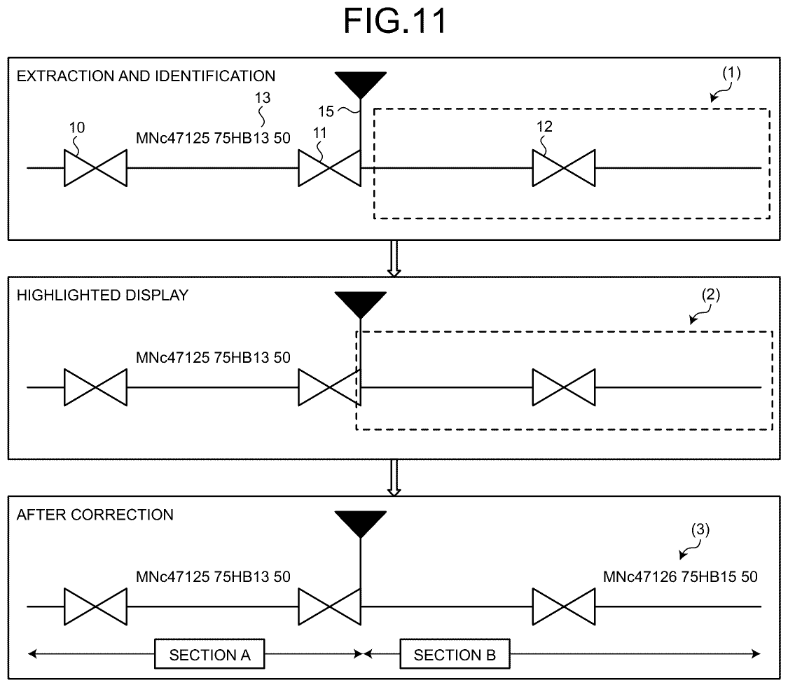

A specific example using the identification condition of “determination (1) of deficiency of piping identification information” illustrated in FIG. 6 will be described below with reference to FIG. 11. As one example, explanation will be given of a case in which the diagram analysis apparatus 100 identifies insufficient input of piping identification information. FIG. 11 illustrates an example in which an input missing position of piping identification information is identified from a design diagram in which a separator symbol is input, but identification information on separated piping is not input at a separation position, the input missing position is displayed in a highlighted manner on the design diagram.

First, an “extraction and identification” step illustrated in FIG. 11 will be described. The diagram analysis apparatus 100 extracts, from the received design diagram, piping, the valves 10 to 12, the piping identification information 13 (MNc47125 75HB13 50), and a separator symbol 15. Further, the diagram analysis apparatus 100 extracts a structure in which the piping that is identified by the piping identification information 13 (MNc47125 75HB13 50) is connected to the right portion of the valve 10 and the left portion of the valve 11, and piping for which piping identification information is unknown is connected from the right portion of the valve 11 to the left portion of the valve 12 and from the right portion of the valve 12.

Subsequently, the diagram analysis apparatus 100 recognizes that the piping on the left side of the valve 11 and the piping on the right side of the valve 11 are different piping because of input of the separator symbol. Further, the diagram analysis apparatus 100 recognizes that the piping identification information 13 (MNc47125 75HB13 50) is input. In contrast, the diagram analysis apparatus 100 recognizes that piping identification information for identifying the piping that is connected from the right portion of the valve 11 to the left portion of the valve 12 and from the right portion of the valve 12 in a range indicated by (1) in FIG. 11 is absent. In this manner, the diagram analysis apparatus 100 identifies, from the design diagram, that the piping identification information is absent because the piping identification information that needs to be present in the recognized range ((1) in FIG. 11) is not included in the extracted components.

A “highlighted display” step illustrated in FIG. 11 will be described below. The diagram analysis apparatus 100 outputs a design diagram in which a candidate position of the identified missing piping identification information is displayed in a highlighted manner by being enclosed in a dashed frame as indicated by (2) in FIG. 11.

Thereafter, as indicated by an “after correction” step in FIG. 11, the diagram analysis apparatus 100 receives input of piping identification information from a user with respect to a position that is selected by the user from in the range that is displayed in a highlighted manner. Further, as indicated by (3) in FIG. 11, the diagram analysis apparatus 100 updates the originally received design diagram with a design diagram in which a missing piping identification number is input. As a result, it becomes possible to identify an identification number of the “section B”.

### Identification of Piping Identification Information at Abnormal Input Position

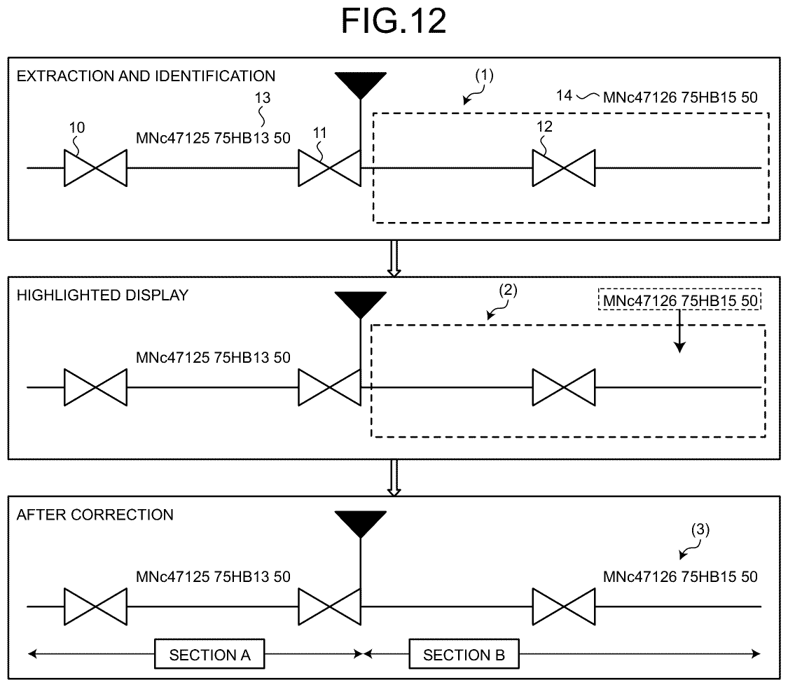

A specific example using the identification condition of “determination (2) of deficiency of piping identification information” illustrated in FIG. 6 will be described below with reference to FIG. 12. As one example, a case will be described in which the diagram analysis apparatus 100 identifies piping identification information at an abnormal input position. FIG. 12 illustrates an example in which an abnormal input position of piping identification information is identified from a design diagram in which the piping identification information is not input within a predetermined distance from piping, and the abnormal input position is displayed in a highlighted manner on the design diagram.

First, an “extraction and identification” step illustrated in FIG. 12 will be described. The diagram analysis apparatus 100 extracts, from the received design diagram, the piping, the valves 10 to 12, the piping identification information 13 (MNc47125 75HB13 50), and the piping identification information 14 (MNc47126 75HB15 50). Further, the diagram analysis apparatus 100 extracts a structure in which the piping that is identified by the piping identification information 13 (MNc47125 75HB13 50) is connected to the right portion of the valve 10 and the left portion of the valve 11, and piping for which piping identification information is unknown is connected from the right portion of the valve 11 to the left portion of the valve 12 and from the right portion of the valve 12.

Subsequently, the diagram analysis apparatus 100 recognizes that the piping on the left side of the valve 11 and the piping on the right side of the valve 11 are different piping because of input of a separator symbol. Further, the diagram analysis apparatus 100 recognizes that the piping identification information 13 (MNc47125 75HB13 50) is input. In contrast, the diagram analysis apparatus 100 recognizes that the piping identification information 14 (MNc47126 75HB15 50) is input, but the piping identification information is not present at a position indicated by (1) in FIG. 12 within the predetermined distance from the piping. In this manner, the diagram analysis apparatus 100 identifies that the position of the piping identification information is not correct because the piping identification information 14 (MNc47126 75HB15 50) is included in the extracted components, but is not present at the recognized position ((1) in FIG. 12).

A “highlighted display” step illustrated in FIG. 12 will be described below. The diagram analysis apparatus 100 outputs a design diagram in which the identification number that is not associated with the piping and a position at which the identified piping identification information is expected to be input are displayed in a highlighted manner by being enclosed by dashed frames as indicated by (2) in FIG. 12.

Thereafter, as indicated by an “after correction” step in FIG. 12, the diagram analysis apparatus 100 receives input of the piping identification information (or correction of the position of the input identification number) from the user with respect to the position that is displayed in a highlighted manner. Further, as indicated by (3) in FIG. 12, the diagram analysis apparatus 100 updates the originally received design diagram with a design diagram in which the piping identification information is input at the expected position. As a result, it becomes possible to identify the identification number of the “section B”.

### Identification of Piping Identification Information Including Erroneous Description

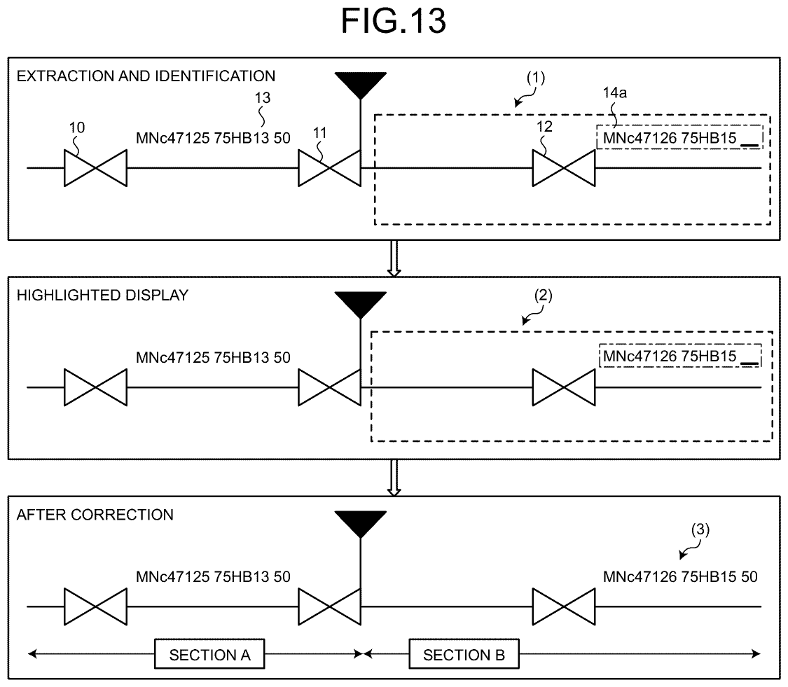

A specific example using the identification condition of “determination (3) of deficiency of piping identification information” illustrated in FIG. 6 will be described below with reference to FIG. 13. As one example, a case will be described in which the diagram analysis apparatus 100 identifies piping identification information that includes erroneous description. In an example illustrated in FIG. 13, a case is illustrated in which the piping identification information is input, but a deficiency of the piping identification information is identified from a design diagram that deviates from the description rule and the deficiency is displayed in a highlighted manner on the design diagram.

First, an “extraction and identification” step illustrated in FIG. 13 will be described. the diagram analysis apparatus 100 extracts, from the received design diagram, the piping, the valves 10 to 12, the piping identification information 13 (MNc47125 75HB13 50), and piping identification information 14a (MNc47126 75HB15). Further, the diagram analysis apparatus 100 extracts a structure in which the piping that is identified by the piping identification information 13 (MNc47125 75HB13 50) is connected to the right portion of the valve 10 and the left portion of the valve 11, and piping that is identified by the piping identification information 14a (MNc47126 75HB15) is connected from the right portion of the valve 11 to the left portion of the valve 12 and from the right portion of the valve 12.

Subsequently, the diagram analysis apparatus 100 recognizes that the piping on the left side of the valve 11 and the piping on the right side of the valve 11 are different piping because of input of a separator symbol. Further, the diagram analysis apparatus 100 recognizes that the piping identification information 13 (MNc47125 75HB13 50) is input. In contrast, the diagram analysis apparatus 100 recognizes that the recognized piping identification information 14a (MNc47126 75HB15) is input but deviates from the description rule, such as omission of input of “50” at the end, and therefore, the diagram analysis apparatus 100 recognizes that description of the piping identification information is insufficient. In this manner, the diagram analysis apparatus 100 identifies that the piping identification information includes erroneous description because the piping identification information 14a (MNc47126 75HB15) is included in the extracted components but described while deviating from the description rule. Meanwhile, with respect to whether the description rule is not complied with, the diagram analysis apparatus 100 is able to identify whether erroneous description is included based on a degree of match between the description rule and details, such as the number of characters, a sequence, or a character type, that constitute the piping identification information.

A “highlighted display” step illustrated in FIG. 13 will be described below. The diagram analysis apparatus 100 outputs a design diagram in which the identified piping identification information including erroneous description is displayed in a highlighted manner by being enclosed by a dashed frame as illustrated in (2) in FIG. 13.

Thereafter, as indicated by an “after correction” step in FIG. 13, the diagram analysis apparatus 100 receives input of correction or the like of the piping identification information including erroneous description from a user with respect to the position that is displayed in a highlighted manner. Further, as indicated by (3) in FIG. 13, the diagram analysis apparatus 100 updates the originally received design diagram with a design diagram in which the piping identification information is input in accordance with a correct description rule. As a result, it becomes possible to identify the identification number of the “section B”.

### Identification of Component Related to Occurrence of Contradiction of Fluid Flow Direction

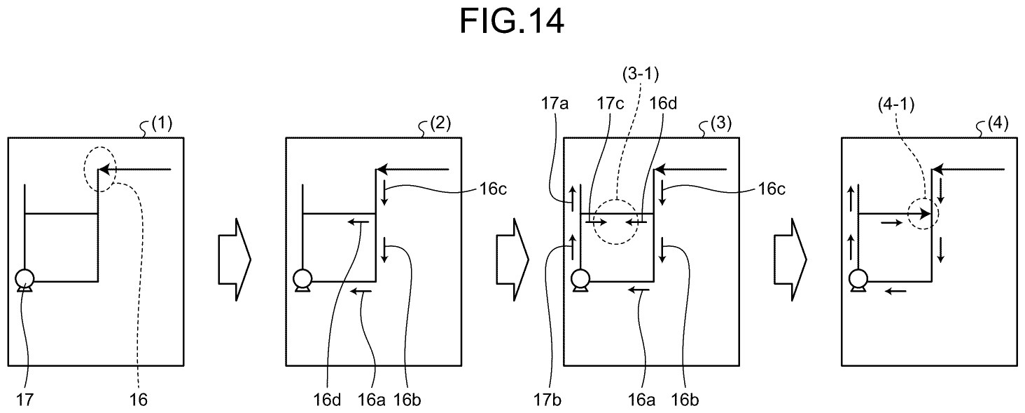

A specific example using the identification condition of a “deficiency of a fluid flow direction symbol” illustrated in FIG. 6 will be described below with reference to FIG. 14. As one example, a case will be described in which the diagram analysis apparatus 100 identifies a component related to occurrence of contradiction of the fluid flow direction. FIG. 14 illustrates an example of identifies, from a design diagram that includes a position at which contradiction of a fluid flow direction in piping occurs, the positon at which the contradiction occurs as a deficiency of a fluid flow direction symbol, and displaying the position in a highlighted manner on the design diagram.

First, the diagram analysis apparatus 100 extracts, from the received design diagram, piping, a symbol 16 that represents a fluid flow direction, and a pump 17. Further, the diagram analysis apparatus 100 extracts a structure in which the symbol 16 that represents the fluid flow direction is described so as to represent a right to left flow direction on the piping illustrated in (1) in FIG. 14, and the piping is connected to an upper right portion of the pump 17. Meanwhile, the piping including the symbol 16 representing the fluid flow direction as illustrated in (1) in FIG. 14 indicates that a fluid in the piping flow from right to left in (1) in FIG. 14. Further, the pump 17 illustrated in (1) in FIG. 14 may cause the fluid that is input from right in (1) in FIG. 14 to flow in an upward direction. Furthermore, as illustrated in (2) in FIG. 14, the diagram analysis apparatus 100 recognizes the fluid flow direction in the piping, which is indicated by the symbol 16 representing the extracted fluid flow direction, as provisional directions represented by arrows 16a to 16d. Furthermore, as illustrated in (3) in FIG. 14, the diagram analysis apparatus 100 recognizes fluid flow directions in the piping, which are generated by the extracted pump 17, as provisional directions represented by arrows 17a to 17c.

Subsequently, because the fluid flow direction in the piping as indicated by the recognized arrow 16d is a right to left direction in the drawing and the fluid flow direction in the piping as indicated by the arrow 17c is a left to right direction in the drawing, the diagram analysis apparatus 100 identifies that a fluid flow direction contradiction has occurred with respect to the fluid flow direction at a position in the design diagram as illustrated in (3-1) in FIG. 14.

Then, if it is possible to determine a correct fluid flow direction with respect to the position at which the identified fluid flow direction contradiction has occurred, the diagram analysis apparatus 100 automatically inputs a symbol of the arrow or outputs a correct arrow direction to the user. In contrast, if it is difficult to determine a correct fluid flow direction, the diagram analysis apparatus 100 outputs a design diagram including highlighted display, such as enclosing by a dashed frame, as indicated by (3-1) in FIG. 14. Meanwhile, the diagram analysis apparatus 100 may output a design diagram including highlighted display, such as enclosing by a dashed frame, even when it is possible to determine a correct fluid flow direction.

Thereafter, as illustrated in (4) in FIG. 14, the diagram analysis apparatus 100 receives input of an arrow symbol or the like for resolving the identified fluid flow direction contradiction from the user with respect to the position that is displayed in a highlighted manner. Further, as illustrated in (4) in FIG. 14, the diagram analysis apparatus 100 updates the originally received design diagram with a design diagram in which the symbols indicating the fluid flow directions are input without contradiction. As a result, a contradiction of the fluid flow direction in the design diagram is resolved.

### Effects

As described above, the extraction unit 152 of the diagram analysis apparatus 100 according to the first embodiment extracts, from a design diagram of a plant, components of the design diagram. The identification unit 153 of the diagram analysis apparatus 100 identifies at least one of a setting position of setting information corresponding to an identification condition and a setting detail of the setting information in the design diagram, based on the components of the design diagram. Therefore, according to the first embodiment, it is possible to achieve the effects as described below.

The diagram analysis apparatus 100 identifies a defective diagram portion in the design diagram without using a correct design diagram that is registered in advance, or the like. With this configuration, the user is able to reduce the number of man-hours for extracting a correction portion in the design diagram and the number of man-hours for correcting the design diagram, so that it is possible to improve quality of the diagram. Further, the user is able to obtain unique and correct information from the design diagram.

Specifically, the diagram analysis apparatus 100 detects a deficiency of the design diagram, which is difficult to be detected visually by human being, and makes it possible to simplify correction of the deficient design diagram. With this configuration, the user is able to effectively and accurately correct even a complicated design diagram which includes a large amount of information and in which insufficient detection, insufficient correction, erroneous correction, or the like is likely to occur.

Furthermore, as described above, the diagram analysis apparatus 100 is able to detect a defective diagram portion without using a correct design diagram that is registered in advance, or the like. With this configuration, the diagram analysis apparatus 100 is able to perform extraction and identification without receiving correct information every time for extracting insufficient detection, insufficient correction, erroneous correction, or the like from the design diagram, so that it is possible to increase a processing speed of a computer. Moreover, the number of man-hours for preparing a correct diagram at the time of correcting the design diagram or for performing checking by a skilled user who is well experienced is reduced, so that the user is able to more effectively correct the design diagram.

Furthermore, with the functions as described above, for example, even if information is missing when a paper design diagram is digitized or when the digitized design diagram is converted, the diagram analysis apparatus 100 is able to identifying a missing portion. With this configuration, the user is able to effectively verify or correct the design diagram.

Moreover, the identification unit 153 identifies the setting position of the setting information or the setting detail of the setting information or any combination thereof corresponding to the identification condition for identifying a deficiency of a piping separator symbol, a deficiency of piping identification information, or a deficiency of a fluid flow direction symbol or any combination thereof. Specifically, the identification unit 153 identifies a defective diagram portion based on at least one of the piping identification information and the piping separator symbol included in the design diagram components.

Specifically, when identification information is different between identification information on first piping and identification information on second piping among pieces of piping identification information and when the piping separator symbol is absent, the identification unit 153 identifies, based on the piping identification information included in the design diagram components, an input target position of the piping separator symbol as the setting position of the setting information corresponding to the deficiency of a piping separator symbol. Therefore, even when a separator symbol that identifies a separation position of piping in the design diagram is absent, the diagram analysis apparatus 100 is able to identify the separation position. With this configuration, the user is able to effectively perform correction or the like.

Moreover, when the piping separator symbol is present but when at least one of the identification information on the first piping and the identification information on the second piping that are separated by the piping separator symbol is absent, the identification unit 153 identifies, based on the piping separator symbol included in the design diagram components, an input target position corresponding to the absent piping identification information as the setting position of the setting information corresponding to the deficiency of the piping identification information. Therefore, even when identification information is absent in the design diagram, the diagram analysis apparatus 100 is able to identify a corresponding position. With this configuration, the user is able to effectively perform correction or the like.

Furthermore, the identification unit 153 identifies a contradiction of the fluid flow direction between a fluid flow direction in piping that is identified by setting information set in the design diagram and a fluid flow direction that is generated by a facility for operating a fluid that is identified by the setting information set in the design diagram. Moreover, the identification unit 153 identifies a setting position of setting information corresponding to the deficiency of the fluid flow direction symbol that causes a contradiction of the fluid flow direction. Therefore, even when a contradiction of the setting information in the design diagram occurs due to deficiencies of the design diagram components and unambiguous interpretation is difficult, the diagram analysis apparatus 100 is able to identify a corresponding position. With this configuration, the user is able to effectively perform correction or the like.

Moreover, the identification unit 153 identifies, as a setting detail of the setting detail corresponding to the deficiency of the piping identification information, piping identification information that meets a predetermined identification condition including at least one of a character type, the number of characters, and a sequence. With this configuration, the diagram analysis apparatus 100 is able to identify piping identification information or the like that includes erroneous description in descriptions of the design diagram. Therefore, the user is able to effectively perform correction or the like.

### Second Embodiment

In the first embodiment as described above, the example has been described in which a deficiency of a piping separator symbol, a deficiency of piping identification information, a deficiency of a fluid flow direction symbol, or the like is identified; however, in a second embodiment, an example will be described in which the diagram analysis apparatus 100 proactively identifies an input candidate position and notifies a user of the input candidate position. Specifically, the diagram analysis apparatus 100 according to the second embodiment identifies, as the input candidate position, a candidate position at which a design component may be input based on design diagram components extracted from a design diagram. In the second embodiment, a setting position of setting information corresponding to an identification condition or a setting detail of the setting information includes an input candidate position at which a design diagram component, such as a piping separator symbol or piping identification information, may be input. Further, the design diagram components are the same as those of the first embodiment.

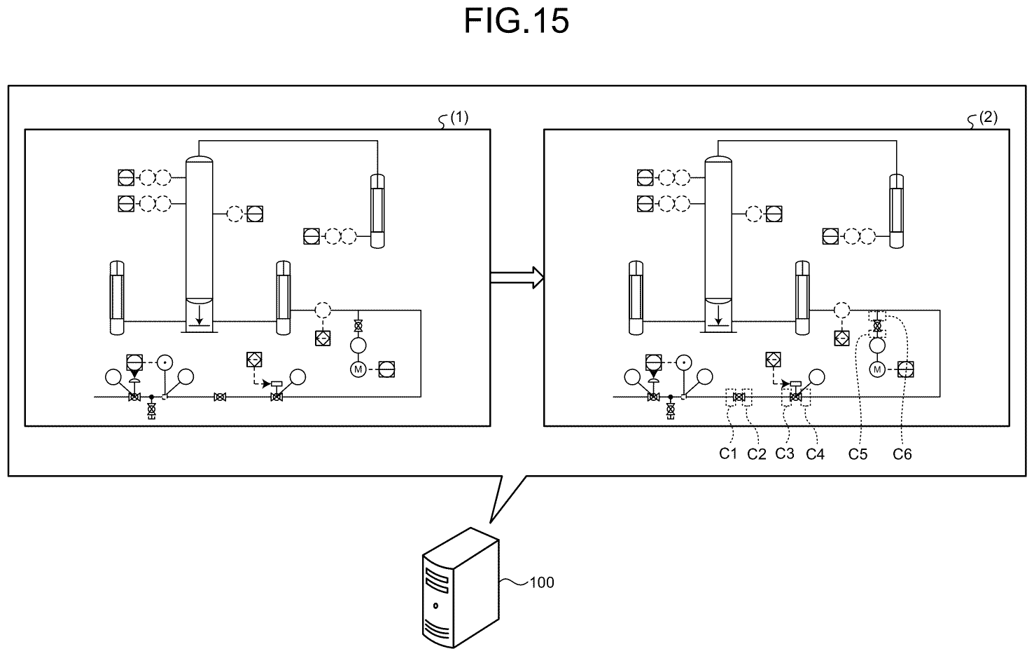

A process performed by the diagram analysis apparatus 100 according to the second embodiment will be described below. FIG. 15 is a diagram for explaining a diagram analysis process according to the second embodiment.

As illustrated in FIG. 15, the diagram analysis apparatus 100 design diagram components from a design diagram ((1) in FIG. 15). Subsequently, the diagram analysis apparatus 100 identifies, based on the extracted design diagram components, candidate positions C1 to C6 that are input candidate positions for a separator symbol or piping identification information ((2) in FIG. 15). Further, for example, the diagram analysis apparatus 100 outputs a design diagram in which the identified candidate positions C1 to C6 are superimposed ((2) in FIG. 15).

In this manner, the diagram analysis apparatus 100 is able to identify an input candidate position of a symbol to be input, with respect to a design diagram that is not yet generated or that is being generated.

### Configuration of Diagram Analysis Apparatus

Functions different from the first embodiment will be described in detail below. The diagram analysis apparatus 100 according to the second embodiment includes the same functional units as those of the diagram analysis apparatus 100 according to the first embodiment, and therefore, an identification condition DB 142 and an identification unit 153 that are differences from the first embodiment will be described below, and explanation of the other units will be omitted appropriately.

### Identification Condition DB 142

The identification condition DB 142 according to the second embodiment stores therein, in addition to the information that is stored in the identification condition DB 142 according to the first embodiment illustrated in FIG. 6, a condition or the like for determining a component to be input at a predetermined position, such as an input candidate position of a separator symbol or piping identification information, and for determining a position of the component.

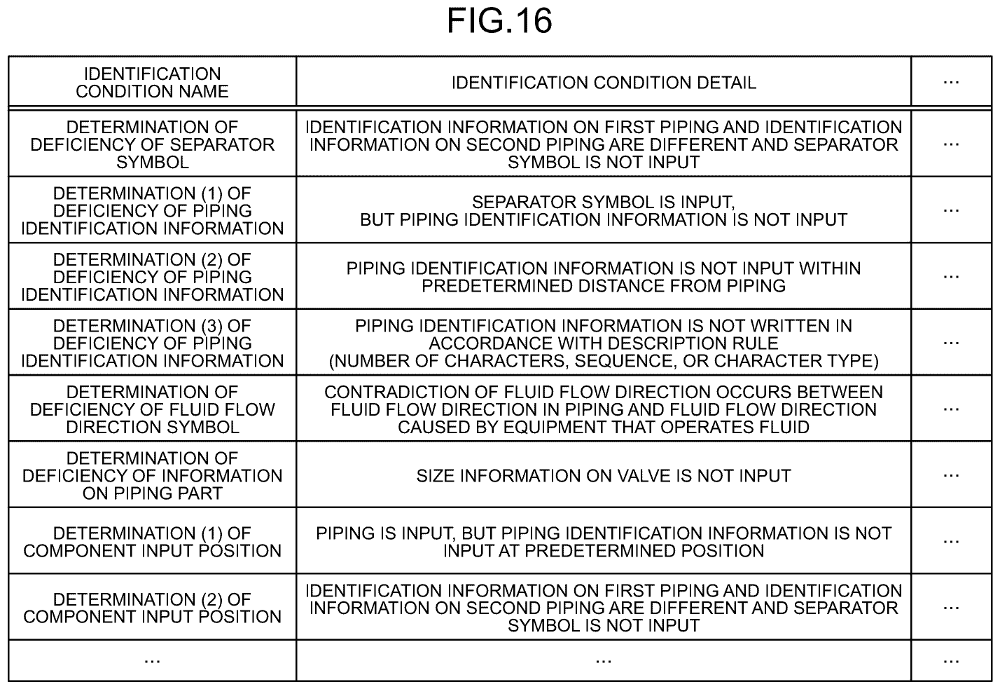

FIG. 16 is a table diagram illustrating an example of identification conditions according to the second embodiment. As illustrated in FIG. 16, the identification condition DB 142 according to the second embodiment stores therein, as the identification conditions, an “identification condition name”, an “identification condition detail”, and the like similarly to the first embodiment.

For example, the identification condition DB 142 stores therein an identification condition name of “determination (1) of component input position” and an identification condition detail of “piping is input, but piping identification information is not input at predetermined position” in an associated manner. In other words, when piping identification information for identifying piping input in the design diagram is not at a position at which the piping identification information needs to be input, the identification condition DB 142 stores therein a condition for identifying an input candidate position of the piping identification information.

For example, the identification condition DB 142 stores therein an identification condition name of “determination (2) of component input position” and an identification condition detail “identification information on first piping and identification information on second piping are input and separator symbol is not input” in an associated manner. In other words, the identification condition DB 142 stores therein a condition for determining a piping switching position based on the piping identification information that is input in the design diagram, and identifying an input candidate position of a separator symbol.

### Identification Unit 153

The identification unit 153 of the diagram analysis apparatus 100 according to the second embodiment identifies, as a setting position of setting information, an input candidate position of piping identification information or a piping separator symbol that meets an identification condition in the design diagram, based on a line segment that represents piping included in the design diagram components. Specifically, the identification unit 153 identifies a candidate input component, such as a separator symbol or piping identification information from among the extracted piping, the extracted piping identification information, the extracted separator symbol, the extracted valve, the extracted pump, and the like. Further, the identification unit 153 identifies an input candidate position or the like of the separator symbol or the piping identification information that is identified as a candidate input.

For example, the identification unit 153 identifies an input candidate position of piping, a separator symbol, or the like that corresponds to an identification condition detail associated with the identification condition name of “determination (1) of component input position” in FIG. 16. Specifically, the identification unit 153 identifies an input candidate position of piping identification information that is not yet input.

For example, the identification unit 153 identifies an input candidate position of piping, a separator symbol, or the like that corresponds to an identification condition detail associated with the identification condition name of “determination (2) of component input position” in FIG. 16. Specifically, the identification unit 153 identifies an input candidate position of a separator symbol that is not yet input.

### Example of Diagram Analysis Process

### Identification of Candidate Input Position of Component

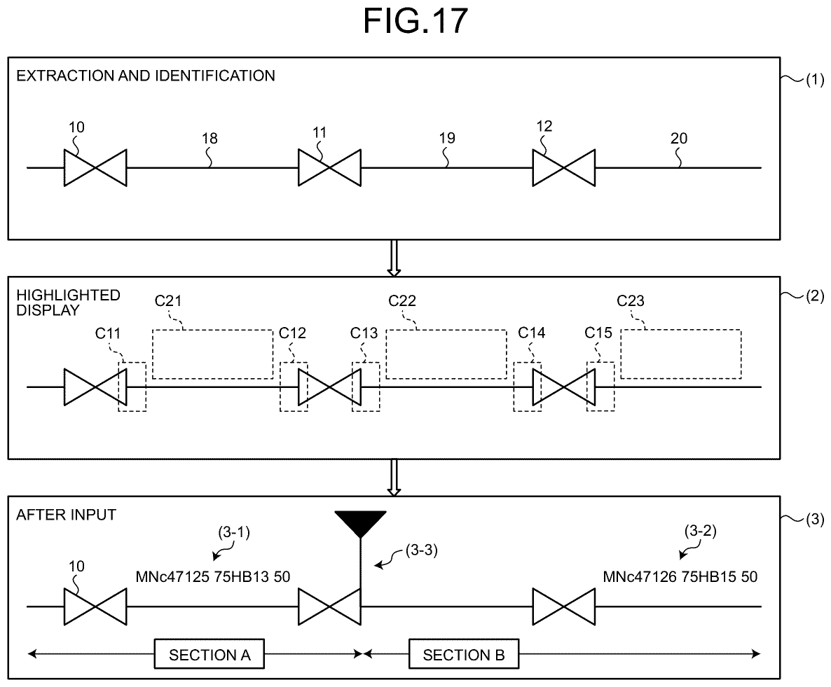

A specific example in which the diagram analysis apparatus 100 identifies a candidate input position of a component in the design diagram by using “determination (1) of component input position” and “determination (2) of component input position” in FIG. 16. FIG. 17 is a diagram illustrating an example of a diagram analysis process according to the second embodiment. FIG. 17 illustrates an example in which input candidate positions are identified from a design diagram in which piping identification information and a separator symbol are not input, and the input candidate positions are displayed in a highlighted manner on the design diagram.

First, an “extraction and identification” step illustrated in FIG. 17 will be described. The diagram analysis apparatus 100 extracts, from the received design diagram, the piping, the valves 10 to 12, and piping 18 to 20 as design diagram components. Further, the diagram analysis apparatus 100 extracts a structure in which the piping 18 is connected to the right portion of the valve 10 and the left portion of the valve 11, the piping 19 is connected to the right portion of the valve 11 and the left portion of the valve 12, and the piping 20 is connected to the right portion of the valve 12.

Subsequently, the diagram analysis apparatus 100 recognizes that piping identification information is not input because the piping is input, but piping identification information is not input at a predetermined position of the piping. Further, the diagram analysis apparatus 100 identifies input candidate positions C11 to C15 as illustrated in (2) in FIG. 17, as input candidate positions at which piping identification information that is not yet input may be input.

Subsequently, the diagram analysis apparatus 100 outputs a diagram in which the identified input candidate positions C11 to C15 are displayed in a highlighted manner by being enclosed by dashed frames as illustrated in (2) in FIG. 17. Thereafter, the diagram analysis apparatus 100 receives input of piping identification information or the like from a user with respect to the input candidate position that is displayed in a highlighted manner. Further, the diagram analysis apparatus 100 updates the originally received design diagram illustrated in (1) in FIG. 17 with a design diagram in which piping identification symbols are input as indicated by (3-1) and (3-2) in FIG. 17.

Furthermore, the diagram analysis apparatus 100 recognizes that a piping separator symbol is not yet input because the piece of piping identification information are input, but a piping separator symbol is not input at a separation position of the piping. Moreover, the diagram analysis apparatus 100 identifies, as input candidate positions at which piping separator symbols that are not yet input may be input, input candidate positions C21 to C23 as illustrated in (2) in FIG. 17.

Subsequently, the diagram analysis apparatus 100 outputs a design diagram in which the identified input candidate positions C21 to C23 are displayed in a highlighted manner by being enclosed by dashed frames as illustrated in (2) in FIG. 17. Thereafter, the diagram analysis apparatus 100 receives input of a piping separator symbol from the user with respect to the input candidate position that is displayed in a highlighted manner. Further, the diagram analysis apparatus 100 updates the originally received design diagram illustrated in (1) in FIG. 17 with a design diagram in which a separator symbol is input as indicated by (3-3) in FIG. 17.

In this manner, the diagram analysis apparatus 100 is able to assist input such that the user is able to effectively and accurately input piping identification information or the separator symbol to the input candidate position.

### Flow of Diagram Analysis Process

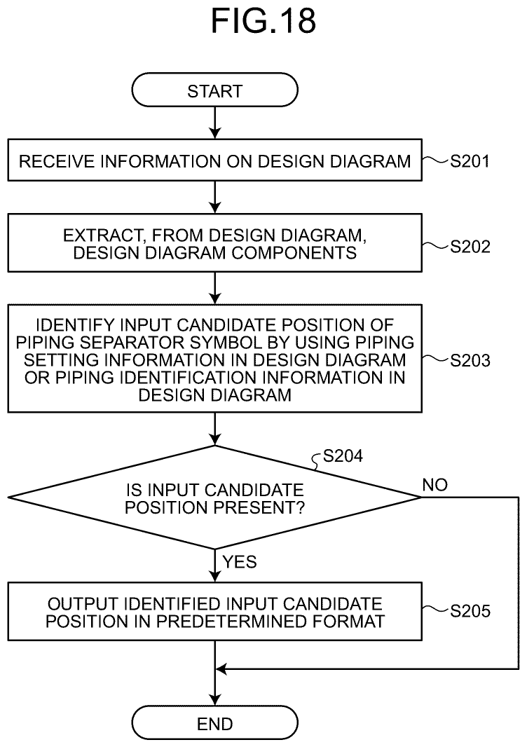

A flow of the diagram analysis process according to the second embodiment the diagram analysis process will be described below. FIG. 18 is a flowchart illustrating the flow of the diagram analysis process according to the second embodiment. Steps described below may be performed in different order as long as not contradiction is derived, or any process may be omitted.

As illustrated in FIG. 18, the reception unit 151 receives information on a design diagram that is obtained by digitizing a paper design diagram based on an image analysis or the like, or information on a design diagram that is designed by a computer based on CAD or the like (S201).

The extraction unit 152 extracts, from the design diagram, design diagram components, such as piping, piping identification information, and a separator symbol, by using an algorithm or the like for pattern matching, an image recognition process, or the like (S202).

The identification unit 153 identifies, with use of piping setting information, such as a line segment that represents piping included in the design diagram components of the design diagram, an input candidate position of piping identification information or a piping separator symbol on the design diagram (S203).

Here, if the identification unit 153 does not identify the input candidate position (No at S204), the diagram analysis apparatus 100 terminates the process. In contrast, if the identification unit 153 identifies the input candidate position (Yes at S204), the output unit 154 outputs the identified input candidate position in a predetermined format (S205). Then, the diagram analysis apparatus 100 terminates the process.

### Effects

As described above, the extraction unit 152 of the diagram analysis apparatus 100 according to the second embodiment extracts design diagram components from a design diagram of a plant. The identification unit 153 of the diagram analysis apparatus 100 identifies at least one of a setting position of setting information corresponding to an identification condition and a setting detail of the setting information in the design diagram based on the design diagram components. Specifically, the identification unit 153 identifies, based on a line segment that represents piping included in the design diagram components, one of piping identification information that meets the identification condition in the design diagram and an input candidate position of a piping separator symbol as the setting position of the setting information. Therefore, according to the second embodiment, it is possible to achieve the effects as described below.

The diagram analysis apparatus 100 extracts, at a step in which a design diagram is not yet generated or a step in which the design diagram is being generated, an input candidate position of information to be described in the design diagram without using a correct design diagram or the like that is registered in advance, and outputs the input candidate position to a user. With this configuration, the user is able to reduce the number of man-hours for generating a design diagram and improve quality of the diagram. Further, the user is able to obtain unique and correct information from the design diagram when generating or referring to the design diagram.

Furthermore, as described above, the diagram analysis apparatus 100 is able to extract a defective diagram portion without using a correct design diagram or the like that is registered in advance. Therefore, even when a correct drawing is absent at the time of generation of a design diagram, the user is able to more effectively generate or edit the design diagram.

### Modification

Modifications of the diagram analysis apparatus 100 according to the first embodiment and the second embodiment will be described below. The modifications may be individually implemented, or may be implemented by being combined as long as no contradiction is derived.

### Numeral Etc.

Processing conditions, information on the components, the number of computers, a user, a process, a process name, and the like used in the embodiments as described above are described as one example, and may be changed appropriately. Further, the identification conditions stored in the identification condition DB 142 may be threshold for determining an insufficiency, a deficiency, or a candidate position. Furthermore, the “state” stored in the component DB 144 may be a numeral that identifies a state set in advance.

### Design Diagram

In relation to the diagram analysis apparatus 100 as described above, the design diagram need not always indicate a P&ID (piping and instrumentation diagram), but may be a predetermined diagram. For example, the design diagram may include a system configuration diagram that represents configurations of a plurality of information processing apparatuses or the like, an instrumentation and piping system diagram that represents a relationship between a control panel and instruments, a sequence diagram in which equipment control, connection points of the equipment, and the like are developed in an operational sequence.

### Recognition of Piping

The diagram analysis apparatus 100 may recognize each piping based on the piping identification information or attribute information, such as a material of piping or a size of piping, when recognizing piping that is included in the design diagram. Specifically, the diagram analysis apparatus 100 is able to identify each piping by recognizing a character string, such as the piping identification information of “MNc47125 75HB13 50”. Further, the diagram analysis apparatus 100 is able to identify each piping based on attribute information, such as a model number, a size of piping, or a material, which is included in the piping identification information of “MNc47125 75HB13 50”.

### Different Mode of Process of Extracting Defective Diagram Portion

When identifying and outputting the defective diagram portion as described above, the diagram analysis apparatus 100 is able to perform list display or continuous display of a plurality of defective diagram portions. For example, the diagram analysis apparatus 100 is able to simultaneously display a plurality of identified defective diagram portions on the design diagram. Further, for example, the diagram analysis apparatus 100 is able to display a plurality of identified defective diagram portions while sequentially transitioning from a first position to a second position based on operation, such as pressing of a predetermined button, by a user. With this configuration, the diagram analysis apparatus 100 is able to more simplify operation when a user verifies or corrects a defective diagram portion in the design diagram, and makes it possible to improve operation efficiency.

### Process of Correcting Defective Diagram Portion

When identifying and outputting the defective diagram portion as described above, the diagram analysis apparatus 100 is able to receive a process of adding, deleting, or editing a defective diagram portion based on operation performed by a user. For example, when a “separator symbol is absent”, the diagram analysis apparatus 100 displays a corresponding position in a highlighted manner; however, it may be possible to further receive a change of information to “add separator symbol to corresponding position”, and reflect the change in the design diagram. With this configuration, the diagram analysis apparatus 100 is able to more simplify operation when a user verifies or corrects a defective diagram portion in the design diagram and makes it possible to improve operation efficiency.

### Highlighted Display of Defective Diagram Portion

The diagram analysis apparatus 100 identifies the defective diagram portion as described above, and outputs the defective diagram portion in a predetermined format to a user. In this case, the diagram analysis apparatus 100 is able to display each piping section with the same attribute by using a different color. For example, when a piping type of first piping and a piping type of second piping are different, the diagram analysis apparatus 100 displays the piping while changing colors of piping, such as “red” for the first piping and “blue” for the second piping. With this configuration, the diagram analysis apparatus 100 is able to achieve effects to assist visual recognition of the user and understanding of the user, and improve operation performance of verification operation or correction operation on the design diagram.

The diagram analysis apparatus 100 identifies the defective diagram portion as described above, and outputs the defective diagram portion in a predetermined format to the user. In this case, the diagram analysis apparatus 100 is able to display a peripheral component in a highlighted manner, instead of displaying a position at which the defective diagram portion is to be input in a highlighted manner. For example, when a “separator symbol is deficient”, the diagram analysis apparatus 100 is able to represent a change point by a line type, a color, or a thickness of piping that is separated by the separator symbol, instead of highlighting an insertion position of the separator symbol. With this configuration, the diagram analysis apparatus 100 is able to achieve effects to assist visual recognition of the user and understanding of the user, and improve operation performance of verification operation or correction operation on the design diagram.

### System

The processing procedures, control procedures, specific names, and information including various kinds of data and parameters illustrated in the above-described document and drawings may be arbitrarily changed unless otherwise specified

Further, the components of the apparatuses illustrated in the drawings are functionally conceptual and do not necessarily have to be physically configured in the manner illustrated in the drawings. In other words, specific forms of distribution and integration of the apparatuses are not limited to those illustrated in the drawings. That is, all or part of the apparatuses may be functionally or physically distributed or integrated in arbitrary units depending on various loads or use conditions.

Furthermore, for each processing function performed by each apparatus, all or any part of the processing function may be implemented by a Central Processing Unit (CPU) and a program analyzed and executed by the CPU or may be implemented as hardware by wired logic.

### Hardware Configuration

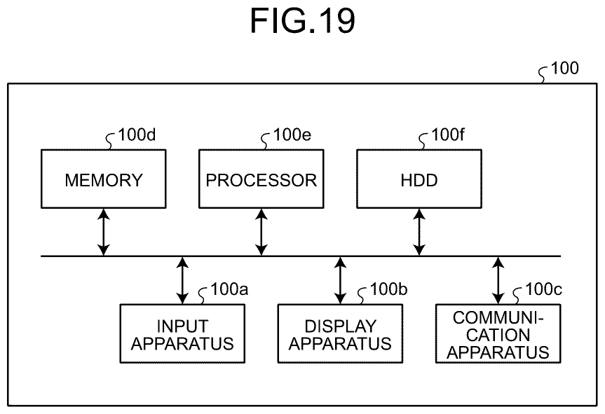

A hardware configuration example of the diagram analysis apparatus 100 will be described below. FIG. 19 is a hardware configuration diagram illustrating an example of a computer that implements functions of the diagram analysis apparatus according to one embodiment. As illustrated in FIG. 19, the diagram analysis apparatus 100 includes an input apparatus 100a, a display apparatus 100b, a communication apparatus 100c, a memory 100d, a processor 100e, and a Hard Disk Drive (HDD) 100f. Further, all of the units illustrated in FIG. 19 are connected to one another via a bus or the like.

The input apparatus 100a is a mouse, a keyboard, or the like, and receives input of information based on operation performed by a user or the like. The display apparatus 100b is a display, a printer, or the like, and outputs information that is analyzed by the diagram analysis apparatus 100 to a user or the like.

The communication apparatus 100c is a network interface card or the like, and performs communication with a different server. The HDD 100f stores therein a program and a DB for operating the functions illustrated in FIG. 19.

The processor 100e reads, from the HDD 100f or the like, a program that executes the same processes as those of each of the processing units illustrated in FIG. 19, loads the program onto the memory 100d, and operates a process for implementing each of the functions illustrated in FIG. 19 or the like. For example, the process implements the same functions as those of each of the processing units included in the diagram analysis apparatus 100. Specifically, the processor 100e executes the process for performing the same processes as those of the reception unit 151, the extraction unit 152, the identification unit 153, the output unit 154, and the like.

As described above, the diagram analysis apparatus 100 operates as an information processing apparatus that implements an analysis method by reading and executing a program. Further, the diagram analysis apparatus 100 is able to implement the same functions as those of the embodiments as described above by causing a medium reading apparatus to read the above-described program from a recording medium, and executing the above-described read program. Meanwhile, the program described in this embodiment need not always be executed by the diagram analysis apparatus 100. For example, the present invention may be similarly applied to a case in which a different computer or a different server executes the program or a case in which the different computer and the different server execute the program in a cooperative manner.

The program may be distributed via a network, such as the Internet. Further, the program may be recorded in a computer-readable recording medium, such as a hard disk, a flexible disk (FD), a compact disk-read only memory (CD-ROM), a Magneto-Optical disk (MO), or a Digital Versatile Disc (DVD), and may be executed by being read from the recording medium by a computer.

### Others

Examples of a combination of disclosed technical features will be described below.

According to the present invention, it is possible to improve quality of a design diagram.

What is claimed is:

1. A diagram analysis apparatus comprising:
a processor configured to:
extract, from a design diagram of a plant, components of the design diagram; and
identify a setting position of setting information corresponding to an identification condition in the design diagram or a setting detail of the setting information in the design diagram or any combination thereof, based on the components of the design diagram.

2. The diagram analysis apparatus according to claim 1, wherein
the processor is further configured to identify the setting position of the setting information or the setting detail of the setting information or any combination thereof corresponding to the identification condition for identifying a deficiency of a piping separator symbol, a deficiency of piping identification information, or a deficiency of a fluid flow direction symbol or any combination thereof.

3. The diagram analysis apparatus according to claim 2, wherein
when identification information is different between identification information on first piping and identification information on second piping among pieces of piping identification information and when the piping separator symbol is absent,
the processor is further configured to identify, based on piping identification information included in the components of the design diagram, an input target position of the piping separator symbol as the setting position of the setting information corresponding to the deficiency of the piping separator symbol.

4. The diagram analysis apparatus according to claim 2, wherein
when the piping separator symbol is present but when at least one of identification information on first piping and identification information on second piping that are separated by the piping separator symbol is absent,
the processor is further configured to identify, based on a piping separator symbol included in the components of the design diagram, an input target position corresponding to the absent piping identification information as the setting position of the setting information corresponding to the deficiency of the piping identification information.

5. The diagram analysis apparatus according to claim 2, wherein
the processor is further configured to identify, as the setting position of the setting information corresponding to the deficiency of the fluid flow direction symbol, a portion at which the fluid flow direction is contradicted between a fluid flow direction in piping that is identified by setting information set in the design diagram and a fluid flow direction that is generated by a facility for operating a fluid that is identified by the setting information set in the design diagram.

6. The diagram analysis apparatus according to claim 2, wherein
the processor is further configured to identify, as a setting detail of the setting information corresponding to the deficiency of the piping identification information, piping identification information that meets a predetermined identification condition including a character type, a number of characters, or a sequence or any combination thereof.

7. The diagram analysis apparatus according to claim 1, wherein
the processor is further configured to identify, based on a line segment that represents piping included in the components of the design diagram, one of piping identification information that meets the identification condition in the design diagram and an input candidate position of a piping separator symbol as the setting position of the setting information.

8. The diagram analysis apparatus according to claim 1, wherein
the processor is further configured to extract the components of the design diagram while adopting, as the design diagram, one of a design diagram that is obtained by digitizing a paper design diagram by an image analysis and a design diagram that is designed based on CAD.

9. A diagram analysis method that causes a computer to execute a process comprising:
extracting, from a design diagram of a plant, components of the design diagram; and
identifying at least one of a setting position of setting information corresponding to an identification condition in the design diagram or a setting detail of the setting information in the design diagram or any combination thereof, based on the components of the design diagram.

10. A non-transitory computer-readable recording medium having stored therein a diagram analysis program that causes a computer to execute a process comprising:
extracting, from a design diagram of a plant, components of the design diagram; and
identifying at least one of a setting position of setting information corresponding to an identification condition in the design diagram or a setting detail of the setting information in the design diagram or any combination thereof, based on the components of the design diagram.
